(19) United States
(12) Patent Application Publication
(10) Pub. No.: US 2010/0251942 A1
(43) Pub. Date: Oct. 7, 2010

(54) REAGENT DRYING VIA EXCESS AIR PREHEAT

(75) Inventor: Kevin J. O'Boyle, Alma, NY (US)

Correspondence Address: ALSTOM Power Inc., 200 Great Pond Drive, P.O. Box 500, WINDSOR, CT, 06095, US

(73) Assignee: ALSTOM Technology Ltd, Baden (CH)

(21) Appl. No.: 12/416,488

(22) Filed: Apr. 1, 2009

(51) Int. Cl. F23J 15/04; F26B 23/02; B01D 53/48

(52) U.S. Cl. 110/215; 34/86; 110/203

(57) ABSTRACT

A reagent drying system for use with a steam generation system [25] is described having a combustion chamber that produces exhaust flue gasses [FG2]. A preheater [150] receives the exhaust flue gasses [FG1] and transfers heat to create a heated input air stream [A2] and a diverted air stream [A2′]. The heated input air stream [A2] is provided to the combustion chamber. The diverted air stream [A2′] is provided to a dryer [196] as incremental air stream [IA]. Dryer [196] dries bulk reagents for dry milling into powder. The powder is then used to process the exhaust flue gasses to remove pollutants. The incremental air stream [IA] may also include leakage gasses [360] from preheater [150].

### CROSS REFERENCE TO RELATED APPLICATIONS

This application is related to U.S. patent Application “Economical Use of Air Preheat” by Glenn D. Mattison and incorporates this patent application by reference as if set forth in its entirety herein. The Mattison patent application is being filed on the same day as the present patent application and both applications have the same owner.

### FIELD OF THE INVENTION

The present invention is directed to a system for capturing additional heat from flue gas output. More particularly, the present invention is directed to a system for capturing additional heat from flue gas for drying of reagents used in flue gas desulphurization operations.

### BACKGROUND

Many power generation systems are powered by steam generated via coal or oil fired boilers. These power generation systems will often incorporate an exhaust processing and heat recovery system (EPHRS) to reduce flue gas emissions and/or recover heat energy expelled via the flue gas stream from the boiler.

A typical power generation system is generally depicted in the diagram shown as FIG. 1. FIG. 1 shows a power generation system 10 that includes a steam generation system 25 and an exhaust processing and heat recovery system (EPHRS) 15 and an exhaust stack 90. The steam generation system 25 includes a boiler 26. The EPRS 15 includes an air preheater 50, a particulate removal system 70 and a wet scrubber system 80. A forced draft (FD) fan 60 is provided to introduce air into the cold side of the air preheater 50. The particulate removal system 70 may be, for example, an electrostatic precipitator (ESP), a fabric filter system (Bag House) or the like.

The air preheater 50 is a device designed to heat air before it is introduced to another process, such as combustion in the combustion chamber of a boiler 26. The air preheater 50 receives air input A1, heats it, and provides it as air stream A2 to the boiler. This is done by recovering heat expelled from the combustion chamber of the boiler 26 via the flue gas stream FG1. By recovering heat from the flue gas FG1, the thermal efficiency of the boiler 26 can be increased and the amount of heat lost is reduced.

Rotary regenerative air preheaters generally exhibit air leakage that results in an increased flow of gasses to downstream gas treatment devices. If this leakage is recovered, its heat may be used for beneficial purposes.

EPHR 15 is commonly configured to include a wet flue gas desulfurization system (WFGD), shown here as wet scrubber 80, which reduces sulfur dioxide (SO₂) emissions that lead to acid rain. These require the use of milled limestone. Wet milling equipment, such as a wet mill 97, is used to reduce the particle size of limestone and/or other reagents to a desired level of fineness. The milled reagents are mixed with additional water in a storage, mixing and injection tank 85 to produce a slurry. The mixed slurry is stored until it is injected into the wet scrubber 80 to neutralize and capture the SO₂.

Grinding dried solids, such as dried limestone, uses dry milling equipment that consumes significantly less energy than wet milling equipment.

In order for dry grinding operations to take place, the moisture content of the solids must be below a specified level. Typically, this is accomplished by using a heated air dryer 96 fired by a fossil fuel burner 94 to evaporate excess moisture from the reagent as shown in FIG. 2. The dried reagents are then milled in a dry mill 98. The drying process requires a significant amount of additional energy to operate.

Elements of the system shown in FIG. 2 function in the same manner as described for FIG. 1 having the same reference numbers.

Thus, an unaddressed need exists in the industry to provide a more efficient method of providing milled reagents for flue gas processing.

### SUMMARY OF THE INVENTION

Embodiments of the present invention provide a reagent drying system for power generation systems that captures additional heat from a flue gas stream. Briefly described, in architecture, one embodiment of the system, among others, can be implemented as follows. A reagent drying system for use with a steam generation system [25] having a dryer [196] configured to receive said incremental air stream [A2′] from an air preheater [150] to dry the bulk reagents. The air preheater [150] is preferably a rotary regenerative air preheater.

The air preheater [150] is adapted to provide excess heated air [A2′], being the additional air above the amount that said steam generation system [25] can use, the excess heated air [A2′] and the leakage gasses [360] being at least part of the incremental air stream [IA] that is provided to the dryer [196].

The dried reagent is then allowed to be milled into powder by dry milling equipment, which requires significantly less energy as compared with wet milling equipment.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The present invention may be better understood and its numerous objects and advantages will become apparent to those skilled in the art by reference to the accompanying drawings in which:

FIG. 1 is a schematic block diagram depicting a prior art power generation system employing wet milling equipment.

FIG. 2 is a schematic block diagram depicting a prior art power generation system employing dry milling equipment.

FIG. 3 is a schematic block diagram depicting a power generation system employing a reagent drying system and dry milling equipment according to one embodiment of the present invention.

FIG. 4 is another schematic block diagram depicting a power generation system employing a reagent drying system and dry milling equipment according to another embodiment of the present invention.

FIG. 5 is a schematic diagram depicting the capture of heated leakage air from air preheater.

FIG. 6 is another schematic block diagram depicting a power generation system employing a reagent drying system, dry milling equipment and a recuperative heat capture and transfer (RHCT) system according to another embodiment of the present invention.

FIG. 7 is an enlarged schematic diagram depicting an embodiment of the RHCT system of FIG. 6.

FIG. 8 is another schematic block diagram depicting a power generation system employing a reagent drying system, dry milling equipment and a dry scrubber according to another embodiment of the present invention.

FIG. 9 is another schematic block diagram depicting a power generation system employing a reagent drying system, dry milling equipment and a dry scrubber according to another embodiment of the present invention.

FIG. 10 is another schematic block diagram depicting a power generation system employing a reagent drying system, dry milling equipment, a dry scrubber and an RHCT according to another embodiment of the present invention.

### DESCRIPTION OF THE INVENTION

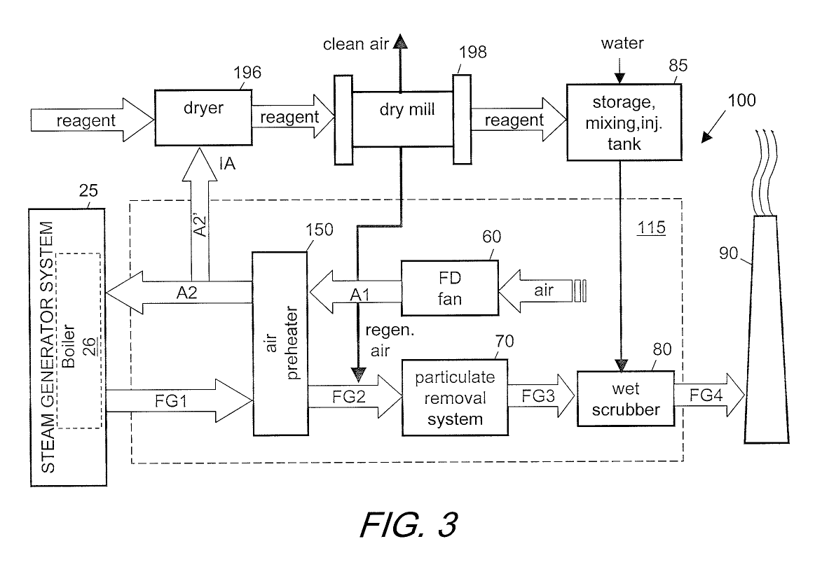

FIG. 3 is a schematic block diagram depicting a power generation system 100 employing a reagent drying system and dry milling equipment according to one embodiment of the present invention.

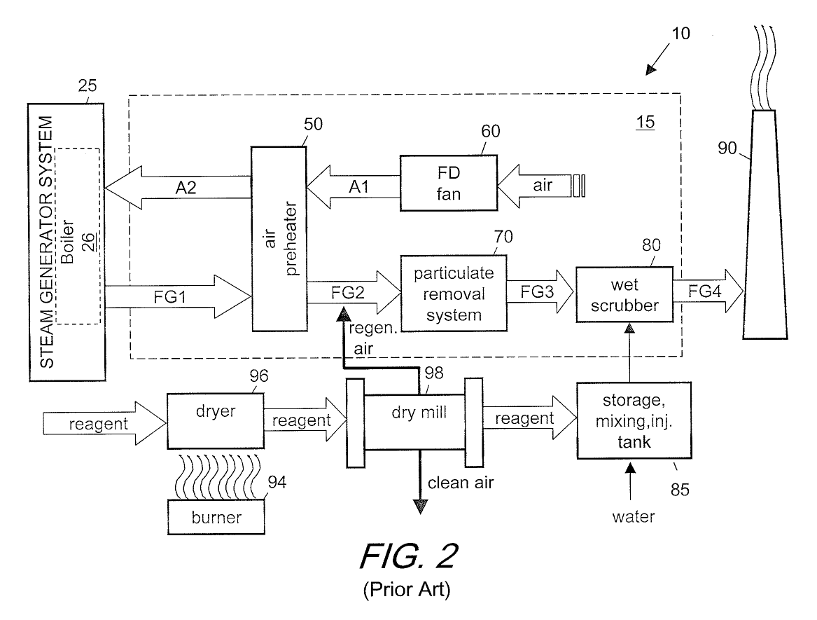

The present invention is directed to providing excess heat from the air preheater 150 to reagent drying operations. Excess heat may generally be defined as thermal energy that exceeds the thermal needs of the steam generation system 25. By using excess heat from the air preheater to conduct reagent drying operations, it is possible to reduce, if not completely eliminate, the need (and thus, expense) for separate gas fired burners (94 of FIG. 2) used to dry reagents prior to milling operations.

In this embodiment a power generation system 100 is provided that includes a steam generation system 25, an exhaust processing and heat recovery system (EPHRS) 115 and an exhaust stack 90. In this embodiment, an incremental air stream IA is provided to reagent dryer 196. Incremental air IA here is diverted air stream A2′ that is a portion of the heated air stream A2 expelled from the air preheater 150. Diverted air stream A2′ may be provided by diverting a portion of the airstream A2 via use of a suitable damper type device (not shown) or appropriate ducting (not shown). In turn, the thermal energy from incremental air stream A2′ is used in drying operation performed by the dryer 196.

The milled reagents are mixed with additional water in a storage, mixing and injection tank 85 to produce a slurry. The mixed slurry is stored until it is injected into the wet scrubber 80 to neutralize and capture the SO₂.

Dry mill 198 functions to mill the reagents into milled reagent of a desired particle size. The clean air from incremental air stream A2′ is exhausted to the atmosphere. Air that needs to be processed is provided to particulate removal system 60 for cleaning.

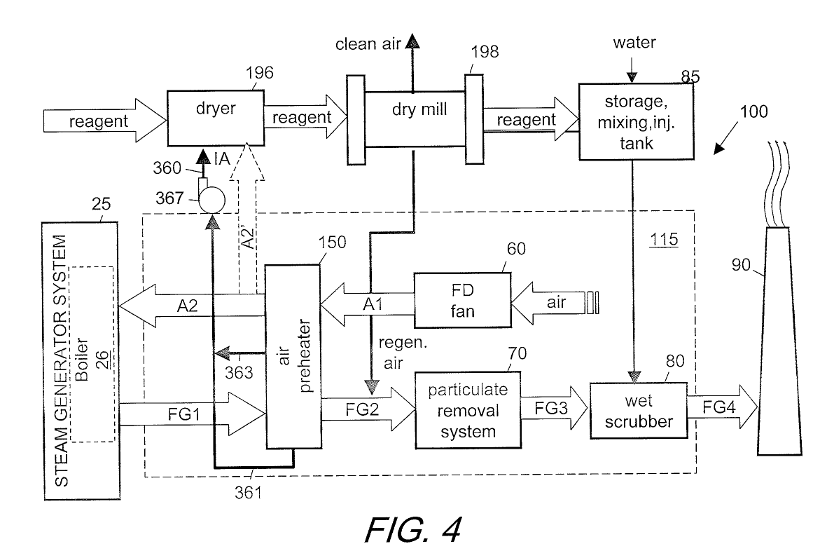

FIG. 4 is another schematic block diagram depicting a power generation system 100 employing a reagent drying system and dry milling equipment according to another embodiment of the present invention. As with all figures, the elements with the same reference numbers perform in the same manner.

Incremental air stream IA is provided to the dryer 196 may be composed of “leakage” gasses 360 or diverted air A2′ (shown in phantom) diverted from the air preheater 150. By only using leakage gasses 360 from the air preheater 150, the entire main heated airstream A2 from the air preheater may be directed to the steam generation system 25.

In an alternative embodiment, it is possible that the incremental air stream IA includes at least part of the leakage gasses 360 and the diverted air stream A2′ to both be sent to dryer 196 as incremental air IA. It is also understood that varying amounts of leakage gasses 360 and the diverted air stream A2′ may be also used with the dryer 196 for all subsequent embodiments described in this application.

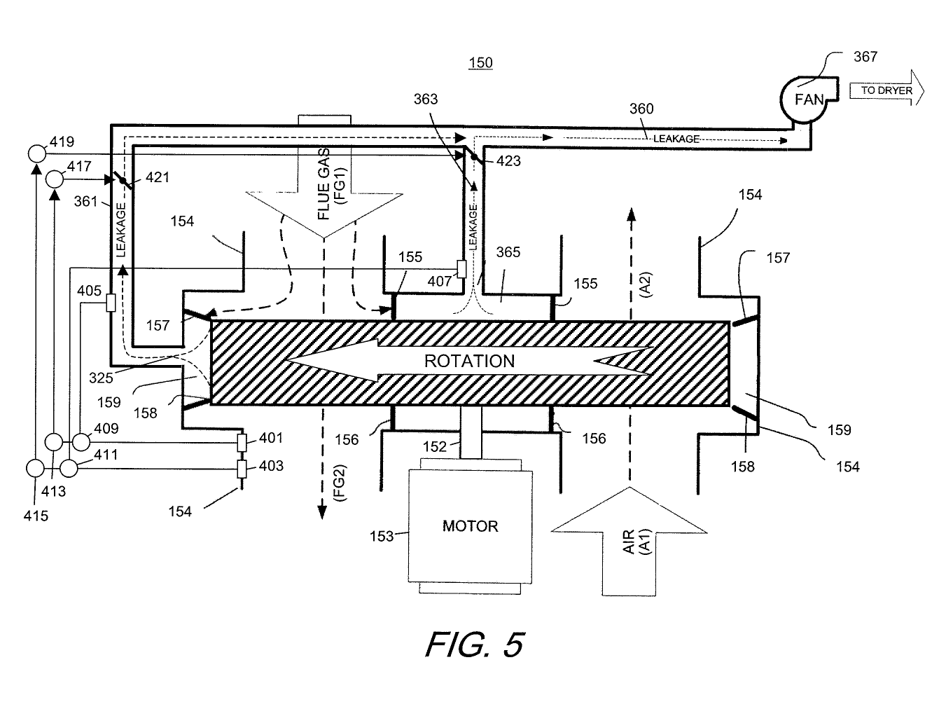

FIG. 5 is a schematic diagram depicting the capture of heated leakage gasses 360 from air preheater 150. Air preheater 150 configured to exhaust leakage air through exhaust conduits 361 from internal plenum 159 within the air preheater 150. In this embodiment, a leakage outlet 325 is provided. This outlet may be implemented as an opening in the housing 154, which allows access to the plenum 159. An exhaust conduit 361 is provided for exhausting gas/air that may accumulate in the internal plenum 159. A fan device 367 may be provided to allow the leakage gasses 360 to be exhausted from the internal plenum 159 more easily.

A further leakage outlet may also be provided so that leakage gasses 360 accumulating within the internal plenum 365 may be readily exhausted through another exhaust conduit 363. Fan 367 also draws the leakage flow from exhaust conduit 363. However, a separate fan may be employed for each exhaust conduit if so desired or otherwise necessary.

In an alternative embodiment, a pressure sensor 401 is positioned within the flue gas outlet to measure flue gas pressure (FG2). Another pressure sensor 405 is positioned within exhaust conduit 361 to measure gas pressure there. A logic unit 409 is connected to sensors 401 and 405 and identifies pressure differences.

A controller 413 is coupled to logic unit 409, and takes action when the pressure difference exceeds a predetermined amount. Controller is connected to an actuator 417 that opens or closes a valve 421 allowing or restricting the leakage gasses in exhaust conduit 361 from flowing to fan 367 and drier 196.

Similarly, a pressure sensor 403 is positioned within the flue gas outlet to measure flue gas pressure (FG2). Another pressure sensor 407 is positioned within exhaust conduit 363 to measure gas pressure there. A logic unit 411 is connected to sensors 403 and 407 and identifies pressure differences.

A controller 415 is coupled to logic unit 411, and takes action when the pressure difference exceeds a predetermined amount. Controller 415 is connected to an actuator 419 that opens and closes a valve 423 allowing or restricting the leakage gasses in exhaust conduit 363 from flowing to fan 367 and drier 196.

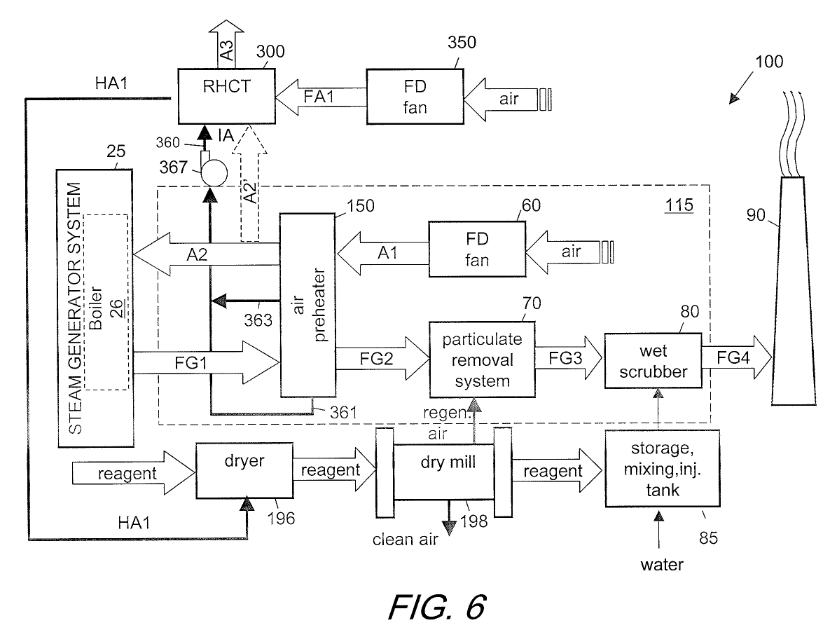

FIG. 6 is another schematic block diagram depicting a power generation system employing a reagent drying system, dry milling equipment, and a recuperative heat capture and transfer (RHCT) system, according to another embodiment of the present invention.

Air preheater 150 will preferably be a high efficiency air preheater capable of outputting a greater volume of heated air than can be efficiently put to use by the steam generation system 25.

RHCT 300 is configured to receive an incremental air stream IA which may be diverted air A2′ from air preheater 150. RHCT 300 extracts thermal energy from incremental air stream IA. Diverted air stream A2′ is a portion of the heated air stream A2 expelled from the air preheater 150. Diverted air stream A2′ may be provided by diverting a portion of the air stream A2 via use of a suitable damper or ducting system (not shown). In turn, the thermal energy extracted from incremental air stream IA is transferred to a heated air stream HA1 and introduced to dryer 196.

Alternatively, leakage gasses 360 from exhaust conduits 361, 363 may also be used as the incremental airstream IA.

RHCT 300 is configured so as to transfer thermal energy from the incremental air stream IA to heated air stream HA1 without introducing any contaminates that may be contained in air stream A2/A2′ or the leakage gasses 360.

Since no flue gas is used by the RHCT 300 to heat the heated airstream HA1, the RHCT 300 is not subjected to particulate matter that is often found in the flue gas streams.

The present invention is applicable to embodiments having an air preheater 150 that have leakage gasses 360. The leakage gasses 360 may be collected and fed via exhaust conduits 361, 363 to fan 367. Even though this is not specifically shown on some of the embodiments, it is assumed that this general feature may be used on other embodiments.

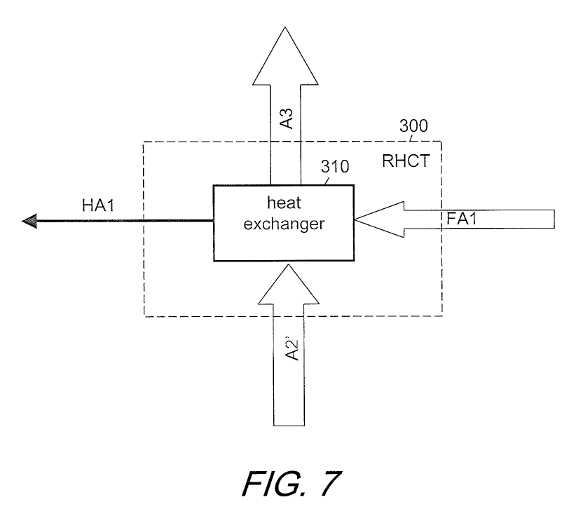

FIG. 7 is an enlarged schematic diagram depicting an embodiment of the RHCT system of FIG. 6. In this embodiment, the RHCT 300 includes heat exchanger 310. Heat exchanger 310 is preferably configured to receive the diverted air A2′ from the air preheater 150. It may also be configured to receive leakage gasses 360 from the air preheater 150.

Since the RHCT 300 is not subjected to the particulate matter typically found in the flue gas streams, it is possible for the heat exchange elements (not shown) used in the heat exchanger 310 to be placed in much closer proximity to each other and thereby provide for more surface area available to contact the incremental air stream IA. In this way, the efficiency of the heat exchanger 310 can be significantly enhanced since the greater the surface area of the heat exchange elements that is provided, the more heat that can be captured for a given volume. Further, since the heat exchange elements are not subjected to much particulate matter, the threat of blockage due to accumulations of particulate matter in the heat exchanger 310 is greatly reduced, if not completely avoided. This reduces the amount of normal maintenance required.

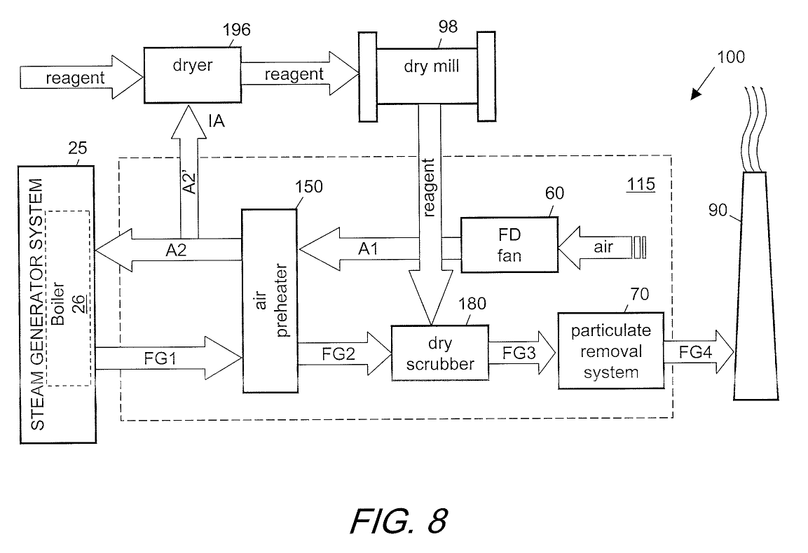

FIG. 8 is another schematic block diagram depicting a power generation system 100 employing a reagent drying system and dry milling equipment according to another embodiment of the present invention.

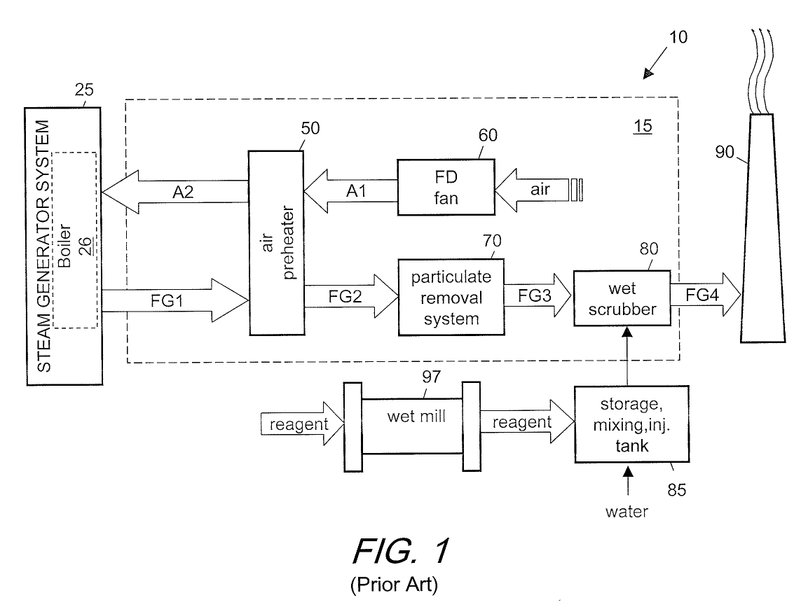

This embodiment shares many of the elements of the embodiment shown in FIG. 3. Elements with the same numbers perform the same functions. However, in this embodiment, a dry scrubber 180 is used in place of the wet scrubber 80 of FIGS. 1-4. This eliminates the need for the storage, mixing tank 85 since aqueous solutions are not used as they are in the wet scrubbers 80.

Dry powder reagents are sprayed into flue gasses FG2 in dry scrubber 180. The powder is distributed as evenly as possible within the flue gas to react with the pollutant gasses in flue gas FG1.

Since dry scrubber 180 employs powders that are sprayed into the flue gasses, it is important to collect the powder prior to exhausting the flue gasses. Therefore, dry scrubber 180 is positioned before the particulate removal system 70 that collects the particulate matter and separates out the gasses that are released through stack 90.

In an alternative embodiment, the dry scrubber may be injection lances feeding powder into a conduit.

These injection lances and/or dry scrubber 180 may also be located between the steam generator system 25 and the air preheater 150 to process the flue gasses FG1.

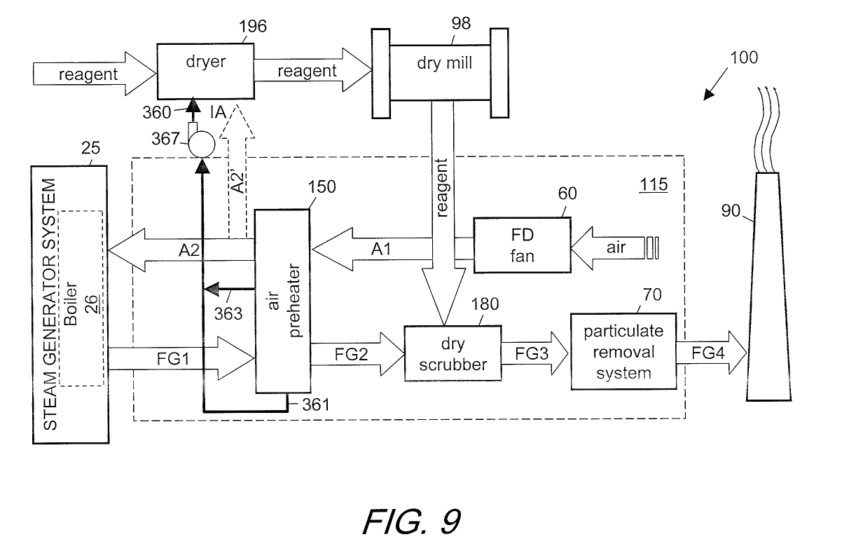

FIG. 9 is another schematic block diagram depicting a power generation system 100 employing a reagent drying system and dry milling equipment according to another embodiment of the present invention.

This embodiment, shares many of the elements of the embodiment shown in FIG. 4, which perform the same functions here. However, a dry scrubber 180 is used in place of the wet scrubber 80 of FIGS. 1-4. As described above, this embodiment employs dry powder reagents to process the flue gasses FG2 in dry scrubber 180.

The dry scrubber 180 is positioned before the particulate removal system 70 that collects the particulate matter, and separates out the gasses that are released through stack 90. Again, in an alternative embodiment, the dry scrubber 180 may be positioned to process flue gasses FG1.

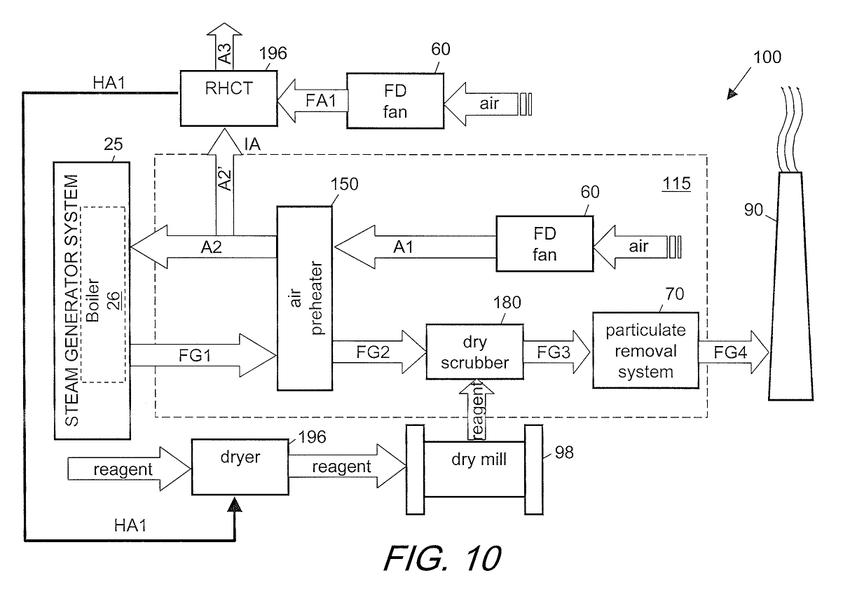

Please note that in the embodiments of FIGS. 3, 4, 6, 8, 9 and 10 the function of drying the reagents performed by dryer 196 prior to milling, may alternatively be performed in the dry mill 198. This effectively would equate to merging the functionality of the dryer 196 and dry mill 198 into a single element.

Please note that this invention is also applicable to other types of air preheaters. For example the scope of this invention covers its use with tri-sector and quad-sector air preheaters commonly known in the industry. A bi-sector air preheater has one duct for receiving hot flue gasses and transfers the heat to one air intake duct.

A tri-sector air preheater has one duct for receiving hot flue gasses and transfers heat to one primary air intake duct and one secondary air intake duct.

A quad-sector air preheater has one duct for receiving hot flue gasses and transfers heat to one primary air intake duct and two secondary air intake ducts. The primary intake duct typically sandwiched between the secondary ducts.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A reagent drying system for use with a steam generation system [25] having a combustion chamber that produces exhaust flue gasses [FG2] comprising:
a dryer [196] configured to receive said incremental air stream [IA] and bulk reagents;
the dryer [196] is further configured to dry the bulk reagents via thermal energy from the incremental air stream [IA] to create dried bulk reagents.

2. The reagent drying system of claim 1 further comprising an air preheater [150] configured to provide the incremental air stream [IA] to dryer [196].

3. The reagent drying system of claim 2 wherein the air preheater [150] is a rotary regenerative air preheater.

4. The reagent drying system of claim 2 wherein the air preheater [150] is configured to heat an input air stream [A1] to create a heated air stream [A2] and a diverted air stream [A2′] and to provide the heated air stream [A2] to said combustion chamber of said steam generation system [25].

5. The reagent drying system of claim 2 wherein the air preheater [150] is further configured to receive the exhaust flue gasses [FG1] from the combustion chamber of the steam generation system [25] and to transfer heat from the exhaust flue gasses [FG1] to the input air stream [A1] to create the heated air stream [A2] that is provided to said combustion chamber.

6. The reagent drying system of claim 2 wherein the air preheater [150] is configured to receive an input air stream [A1] and the exhaust flue gasses [FG1] from the steam generation system [25] and transfer heat from the exhaust flue gasses [FG1] to the input air stream [A1] to create a heated air stream [A2] that is provided to said combustion chamber of said steam generation system [25] and the diverted air stream [A2′] that is provided to the dryer [196].

7. The reagent drying system of claim 5 wherein the dryer [196] comprises:
a recuperative heat capture and transfer system (RHCT) [300] having a heat exchanger [310].

8. The reagent drying system of claim 1 further comprising:
a dry mill [198] for receiving the bulk dried reagents and milling them into milled reagents to a required particle size.

9. The reagent drying system of claim 6 further comprising:
a mixing tank [85] for mixing the milled reagents with water to produce an aqueous slurry; and a wet scrubber [80] for spraying the aqueous slurry into the flue gasses [FG3] to create flue gasses [FG4] having reduced pollutants.

10. The reagent drying system of claim 3 wherein the incremental air stream [A2′] comprises:
leakage gasses [360] from exhaust conduits [361, 363] that are provided to the dryer [196] and part of the incremental air [IA].

11. The reagent drying system of claim 3 wherein air preheater [150] is adapted to provide excess air [A2′], being the additional air above the amount that said steam generation system [25] can use, the excess air [A2′] being at least part of the incremental air stream [IA] that is provided to the dryer [196].

12. The reagent drying system of claim 10 wherein air preheater [150] is adapted to provide excess heated air [A2′], being the additional air above the amount that said steam generation system [25] can use, the excess heated air [A2′] and the leakage gasses [360] being at least part of the incremental air stream [IA] that is provided to the dryer [196].

13. The reagent drying system of claim 6 further comprising:
a dry scrubber [180] adapted for disbursing the milled reagent in the exhaust flue gasses.

14. The reagent drying system of claim 6 further comprising:
a particulate removal system [70] for removing particulate matter from the exhaust flue gasses [FG2].

15. A method of processing exhaust flue gasses from a steam generator system [25] having a combustion chamber for burning fuels and producing the exhaust flue gasses comprising the steps of:
using an air preheater [150] to receive the exhaust flue gasses [FG1] and an input air stream [A1];
transferring heat from the exhaust flue gasses [FG1] to the input air stream [A1] to create a heated air stream [A2] and a diverted air stream [A2′];
providing the heated air stream [A2] to said combustion chamber;
providing bulk reagent and the diverted air [A2′] as an incremental air stream [A2′] to a dryer [196] to produce dried bulk reagent;
dry milling the dried bulk reagent to produce a milled reagent;
providing the milled reagent to the exhaust flue gas [FG1/FG2] to create processed flue gasses [FG4].

16. The method of claim 15, wherein the step of providing the milled reagent comprises the steps of:
mixing the milled reagent with water to produce an aqueous slurry;
spraying the slurry into the exhaust flue gasses [FG3].

17. The method of claim 15, further comprising the step of:
spraying the milled reagent into the exhaust flue gasses.

18. The method of claim 17 wherein the milled reagents are sprayed into the exhaust flue gasses [FG1] prior to the exhaust flue gasses [FG1] being received by the air preheater [150].

19. The method of claim 17 wherein the milled reagents are sprayed into the exhaust flue gasses [FG2] after these gasses have passed through the air preheater [150].

20. The method of claim 15, further comprising the step of:
removing particles in the exhaust flue gasses with a particulate removal system [70].

21. The reagent drying system of claim 2 wherein the air preheater [150] is a bi-sector air preheater.

22. The reagent drying system of claim 2 wherein the air preheater [150] is a tri-sector air preheater.

23. The reagent drying system of claim 2 wherein the air preheater [150] is a quad-sector air preheater.

24. The reagent drying system of claim 10 further comprising:
a system for automatically sensing a pressure of leakage gasses [360] in at least one exhaust conduit [361, 363] and for controlling the flow of leakage gasses [360] based upon the sensed pressure.
